(19) United States
(12) Patent Application Publication
(10) Pub. No.: US 2015/0362015 A1
(43) Pub. Date: Dec. 17, 2015

(54) Device and Method for Magnetically Axially Supporting a Rotor

(71) Applicant: TECHNISCHE UNIVERSITÄT WIEN, Wien (AT)

(72) Inventors: Alexander Schulz, Vienna (AT); Harald Sima, Herzogenburg (AT); Thomas Hinterdorfer, Vienna (AT); Johann Wassermann, Vienna (AT); Manfred Neumann, Vienna (AT)

(73) Assignee: TECHNISCHE UNIVERSITAT WIEN, Vienna (AT)

(21) Appl. No.: 14/762,688

(22) PCT Filed: Jan. 17, 2014
(86) PCT No.: PCT/AT2014/050017

§ 371 Date: Jul. 22, 2015

(30) Foreign Application Priority Data
Jan. 22, 2013 (AT) A 50040/2013

(51) Int. Cl. F16C 32/04

(52) U.S. Cl. CPC F16C 32/0442; F16C 32/0476; F16C 32/0463; F16C 32/0465

(57) ABSTRACT

The invention relates to a device (40) for magnetically axially supporting a rotor, which rotor comprises a thrust bearing plate (32) connected to the rotor, in a magnetic thrust bearing (54) having at least two independently controllable bearing branches (3, 4, 41) which each comprise at least one coil (5, 42), wherein magnetic flux isolation of the bearing branches (3, 4, 41) is provided, which flux isolation consists in that at least two of the bearing branches (3, 4) are arranged one after the other in the circumferential direction and have a single common pole (9) which has a circularly closed circumference, the center point of which is arranged on the axis of rotation (35) of the rotor, wherein the coils (5) surround pole segments (11) connected to the common pole (9) and wherein the common pole (9) is arranged either radially inside or radially outside of the pole segments (11), and/or in that the thrust bearing plate (32) is divided into at least two coaxial plate parts (46, 61) which are associated with different bearing branches (3, 4, 41) and which are separated by a non-magnetic material, for example in the form of a spacer ring (60), wherein the bearing branches (3, 4, or 41) associated with the plate parts (46, 61) are arranged coaxially partially in each other or overlapping.

### TECHNICAL FIELD

The invention relates to a device and a method for magnetically axially supporting a rotor, which rotor comprises a thrust bearing plate connected to the rotor, in a magnetic thrust bearing having at least two independently controllable bearing branches which each comprise at least one coil.

The contactless supporting of rotors by means of magnetic bearings has several advantages as compared to conventional rolling body bearings or sliding bearings. Due to the contactlessness the losses occurring in operation are comparatively low even with speeds of more than 100,000 rpm. The speed limit of conventional bearings, with a given shaft diameter, ranges substantially below that of magnetic bearings which is only limited by the strength of the rotating parts. The contactlessness enables the use of magnetic bearings even in applications in vacuum.

### STATE OF THE ART

U.S. Pat. No. 5,969,451 Å discloses a magnetic bearing with a plurality of coils, wherein the stator arms arranged at the stator may comprise more than one coil. For instance, two coils are arranged in a ring-shaped core with an E-shaped profile, so that the middle part of the core is simultaneously the inner pole of the outer coil and the outer pole of the inner coil. Disadvantageous with this and similar magnetic bearings is the non-monotonous force progression in the case of non-uniform current feed and the required diameter of the thrust bearing plates and the relatively low maximum speed consequently achieved due to the limited mechanical strength. With the bearings illustrated in U.S. Pat. No. 5,969,451 A and with bearings of basically similar construction substantial assembling effort during installation and removal must also be taken into account.

WO 2012/135586 A2 describes a magnetic thrust bearing, wherein, for reducing eddy current, both the stator and the rotor are composed of layers and/or lamellas of soft magnetic material. On one side of the stator a circular arrangement of a plurality of kidney-shaped joints is provided in which coils are arranged. Even if a reduction of eddy current is achieved with this construction, the dimensions of the thrust bearing plate remain substantially unchanged. Another disadvantage of the coil arrangement illustrated here is that a magnetic field is generated between the coils in the circumferential direction which is inverted relative to the interior of the coils. The rotating thrust bearing plate is thus subject to a magnetic field with changing signs, which induces eddy current and thus exerts a braking effect on the rotor. Due to the substantially lower strength of the laminated rotor the maximum speed is further reduced as compared to designs of solid material.

DE 32 40 809 A1 discloses a device for supporting a ring-shaped rotor between two magnetic bearings, each having four bearing branches formed by u-shaped stator ring segments.

CH 646 547 A5 describes an X-ray tube with a rotating anode, wherein a rotor connected with the rotating anode is magnetically supported in three C-shaped magnet yokes of appropriate electromagnets which are displaced by 120°.

JPS 57-73 223 A discloses a magnetic bearing with bearing branches segmented in the circumferential direction, wherein the two poles of the bearing branches are connected by closed ring disks.

### SUMMARY OF THE INVENTION

As compared to the devices known in the state of the art it is an object of the invention to achieve a higher maximum speed with at least comparable reliability and safety, which would in particular be of advantage for flywheel energy storage systems (FESS). Moreover, high energy efficiency and easy assembly and/or disassembly of the device with utmost dimensional accuracy and stability is intended to be achieved.

In accordance with the invention this object is solved in that a magnetic flux isolation of the bearing branches is provided, wherein the flux isolation consists in that at least two of the bearing branches are arranged one after the other in the circumferential direction and have a single common pole which has a circularly closed circumference, the center point of which is arranged on the axis of rotation of the rotor (i.e. the common pole is arranged with the center point concentrical to the axis of rotation), wherein the coils surround pole segments connected to the common pole (wherein it is not segments in the geometric meaning that are meant, but generally sections and/or portions of the assembled yoke) and wherein the common pole is arranged either radially inside or radially outside of the pole segments, and/or in that the thrust bearing plate is divided into at least two coaxial plate parts which are associated with a respective bearing branch and which are separated by a non-ferromagnetic material, wherein the bearing branches associated with the plate parts are arranged coaxially partially in each other or overlapping. In simple terms, the flux isolation is achieved by an azimuthal separation of the bearing branches and/or a radial and/or axial separation of the thrust bearing plate.

Since the single common pole in the azimuthal separation of the bearing parts is only arranged on one side of the coil arrangement and not on both sides, the magnetic flux is concentrated on a particularly small area. This applies in particular in the case of a common pole arranged radially inside the pole segments. Both in the case of an arrangement of the common pole radially inside and in the case of an arrangement of the common pole radially outside it is possible to use a thrust bearing plate with small radial dimensions. This is of advantage so as to achieve a mechanical strain of the thrust bearing plate which is reduced as compared to the state of the art and consequently a higher maximum speed. Due to the arrangement in accordance with a subdivision in the circumferential direction instead of a radial subdivision the magnetic bearing can be compact without renouncing the reliability and resilience achieved by a plurality of coils. The coils are not arranged in each other, but are still connected with one single common pole, so that a magnetic field is produced along this common pole which is largely homogeneous in azimuthal direction, i.e. in the circumferential direction. Moreover, losses from reversal of magnetism in the thrust bearing plate are minimized thereby. Since the coil segments surround pole segments connected to the common pole, stray flux is reduced and/or avoided and the magnetic flux lines are concentrated in the common pole. The pole segments thus form the coil cores, wherein the coils are ideally in direct contact with the pole segments and/or are wound around them, so that the entire magnetic flux generated by the coils runs through the pole segments. Since the pole segments are connected with the common pole, the major portion of the magnetic flux may be directed through the single common pole.

Alternatively or additionally, the flux isolation in accordance with the invention may be achieved by means of a division and/or separation of the thrust bearing plate in the case of bearing branches arranged coaxially partially in each other or overlapping. Thus, it is possible to reduce or avoid stray flux and interactions between the bearing branches, in particular between the separately controlled electromagnets, across the thrust bearing plate, which could lead to non-monotonous force progressions with different current feeds. This facilitates the regulation of the coil controls and contributes to the energy efficiency of the magnetic bearing. An (additional) axial separation is particularly advantageous since the plate parts may in this case each be connected directly with a shaft of the rotor. Moreover, the diameters of the plate parts may be smaller than in the case of a mere radial separation.

In order to achieve a particularly advantageous azimuthal homogeneity of the magnetic field it is favorable if the common pole comprises one single, continuous circular or (fully) circular ring-shaped pole surface and the coils substantially describe concentric circular arcs with the pole surface. The pole surface is the surface of the pole which faces a thrust bearing plate and is separated from the thrust bearing plate only by a gap, preferably of constant breadth. Preferably, the coils are designed such that the coils follow each other substantially directly in the circumferential direction, i.e. substantially form a continuous circle and cover almost the entire angular range of 360°.

It is moreover favorable if the pole segments comprise circular arc-shaped pole surfaces which are substantially concentric with the pole surface of the common pole. Thus it is possible to achieve an almost homogeneous distribution of the flux lines emanating from the pole segments across the entire angular range.

The azimuthal homogeneity of the magnetic field may be further improved and the dimensions of the magnetic thrust bearing may be further reduced if the pole surfaces of the pole segments adjoin each other substantially directly in the circumferential direction. The pole surfaces thus following each other directly in the circumferential direction enable an equal distribution of the magnetic field and prevent that gaps between the pole segments with lower or even effectively inversely poled current induce eddy current in the thrust bearing plate and finally exert a braking effect.

It has turned out to be of particular advantage if with the bearing branches which are arranged partially in each other and/or overlapping the inner diameter of the outer bearing branch is larger than the outer diameter of the plate part of the thrust bearing plate which is associated with the inner bearing branch. The advantage of such design is the easy removability of the rotor from the magnetic thrust bearing and/or the strongly simplified assembly and disassembly of the entire arrangement.

A particularly small required thrust bearing plate area can be achieved if the distance between an inner pole and/or pole segment (the “inner pole”) and an outer pole segment and/or pole (the “outer pole”) of at least one bearing branch increases as the distance to the thrust bearing plate increases. (This means that the poles and/or pole segments are at least partially divergent starting out form the thrust bearing plate.) This counteracts the formation of stray fluxes, on the one hand, and enlarges the available space for the coil(s), on the other hand.

An additional reduction of the required thrust bearing plate area can be achieved if the distance between the inner and the outer contours of at least one pole or pole segment, which means both ring-shaped poles and/or pole rings as well as pole segments, decreases in the direction of the thrust bearing plate. Thus it is possible to increase the flux density in the region of the pole surfaces and to thus achieve better utilization of the material with respect to flux distribution. The resulting possible reduction of the flux density leads to a reduction of the losses from reversal of magnetism.

In order to generate a preferably homogeneous magnetic field in the circumferential direction also in the case of a distance between the pole segments and to avoid field gradients in the circumferential direction, it is favorable if the pole segments comprise, below the coil, in particular in a region between the coil and the pole surface, a projection in the circumferential direction, wherein the length of the projection corresponds approximately to the distance between the end faces of the pole segments, so that, with respect to small flux gradients in the rotating thrust bearing plate, no or just a minimum gap is produced between the pole surfaces, and/or with respect to the best possible isolation of the fluxes of the magnetic branches a preferably large distance is useful, wherein a compromise between the achieved flux isolation and the avoiding of losses from reversal of magnetism is chosen.

The advantages of the previously described designs can be used in a particularly efficient manner if the area of the thrust bearing plate in a plane perpendicular to the axis of rotation is smaller than the sum of the areas of the coils and poles and pole segments in a plane perpendicular to the axis of rotation. Due to the comparatively small thrust bearing plate higher maximum speeds can be used as compared to larger thrust bearing plates of the same material since the mechanical strain of the smaller thrust bearing plate is smaller with the same material (i.e. the same density and strength) and the same speed.

To achieve a balance of forces with respect to the axis of rotation even in the case of irregular current feed of the independent coil branches and to avoid possible torques oriented perpendicular to the axis of rotation, an even number of coils arranged symmetrically to the axis of rotation and opposite to each other with respect to the axis of rotation, and which are each controlled jointly, is favorable. Symmetry means in this context a single or multiple mirror symmetry. However, n-fold rotational symmetries are also meant, wherein n may assume any integer value larger than two (n>2). Here, generally one or two coils may be opposite to one coil, so that on failure of one coil either one coil may be deactivated or two coils may be fed with less current.

In connection with the subdivision of the thrust bearing plate the reliability of the magnetic bearing can be further increased if the magnetic thrust bearing comprises an additional, substantially circular ring-shaped coil interacting with a part of the thrust bearing plate other than the coils following each other in the circumferential direction. In this respect it has turned out to be particularly favorable if the circular ring-shaped coil comprises a full-faced inner pole, wherein the part of the thrust bearing plate opposite to the inner pole forms a full-faced disk which is arranged at the end of the rotor. With this arrangement it is possible to keep the diameter of the thrust bearing plate part small with a predetermined area and/or a predetermined magnetic flux density.

The energy efficiency of the magnetic thrust bearing is particularly advantageous if the magnetic thrust bearing comprises at least one permanent magnet, preferably at least one hybrid magnet with a permanent magnet and an electromagnet. In particular, the permanent magnet may be dimensioned such that the expected average bearing forces are exerted by the permanent magnet and the coils are merely used for stabilization and/or for corrections.

If at least one of the coils has a larger dimension in the axial direction than in the radial direction, it is possible that the magnetic thrust bearing is compact especially in the radial direction and that the overall length of the coil is diminished for the reduction of electrical losses.

In order to achieve a particularly good utilization of the available space, at least one of the coils may have a cross-section converging and/or a radius decreasing towards the thrust bearing plate. This is particularly advantageous in connection with pole shoes converging and/or having a radius decreasing towards a pole surface since it is thus possible to reduce clearances and stray fluxes produced therein, and since the maximum rotor speed increases due to the possible smaller plate diameter.

For improving the reliability of the magnetic thrust bearing and for ensuring the bearing functionality despite a possible failure of one bearing branch it may be provided that the magnetic thrust bearing comprises at least two position sensors which are each associated with different bearing branches. The position sensors may, for instance, be eddy current sensors.

The coils may be controlled in particular by decoupled regulation systems, and in the case of failure of one coil the remaining coils may take over the supporting and stabilization of the rotor. Preferably—with the exception of the rotor—completely separately operating control loops may thus be provided for controlling the coils, so that, if one element, for instance, a coil, a position sensor or control electronics, fails, only the respective control loop is affected and the bearing may still be stabilized by the remaining control loop.

### BRIEF DESCRIPTION OF THE DRAWINGS

The invention will be further explained in the following by means of particularly preferred embodiments to which it is not meant to be restricted, though, and with reference to the drawing. The drawing shows in detail:

FIG. 1 a device with a magnetic thrust bearing with two semicircular coils in a sectional view transverse to an axis of rotation;

FIG. 2 a figurative view of the magnetic thrust bearing of FIG. 1; FIG. 3 schematically a radial section of a coil of a magnetic thrust bearing pursuant to FIG. 2 with a thrust bearing plate and a possible progression of the magnetic field lines;

FIG. 4 a magnetically supported shaft with a magnetic thrust bearing pursuant to FIGS. 1 to 3 at each end of the shaft in a sectional view along an axis of rotation;

FIG. 5 a device with a magnetic thrust bearing with two semicircular coils and with a central bearing branch in a sectional view transverse to an axis of rotation;

FIG. 6 schematically a radial section of the central bearing branch pursuant to FIG. 5 with a possible progression of the magnetic field lines;

FIG. 7 a magnetically supported shaft with a magnetic thrust bearing pursuant to FIGS. 1 to 3 at one end of the shaft and a magnetic thrust bearing pursuant to FIG. 5 at the other end of the shaft in a sectional view along the axis of rotation;

FIG. 8 a variant of the magnetically supported shaft pursuant to FIG. 7 without permanent magnet;

FIG. 9 a further variant of the magnetically supported shaft pursuant to FIG. 7 with converging semicircular coils;

FIG. 10 another variant of the magnetically supported shaft pursuant to FIG. 7 with rounded coil bodies and non-linearly converging pole rings;

FIG. 11 a schematic block diagram of a control circuit for one of the devices pursuant to FIGS. 7 to 10;

FIG. 12 a magnetic thrust bearing with three coils arranged in circular ring-shaped segments in a sectional view transverse to the axis of rotation;

FIG. 13 a magnetic thrust bearing pursuant to FIG. 12 in a sectional view along the axis of rotation according to the line XIII-XIII in FIG. 12;

FIG. 14 a figurative view of the magnetic thrust bearing pursuant to FIGS. 12 and 13;

FIG. 15 a magnetically supported shaft with a magnetic thrust bearing pursuant to FIG. 1 at one end of the shaft and a magnetic thrust bearing pursuant to FIG. 12 at the other end of the shaft in a sectional view along the axis of rotation;

FIG. 16 a FESS external rotor with two magnetic thrust bearings (FESS—Flywheel Energy Storage System); and

FIG. 17 a magnetically supported shaft with magnetic thrust bearings at both ends of the shaft in a sectional view along the axis of rotation.

### DETAILED DESCRIPTION OF THE DRAWINGS

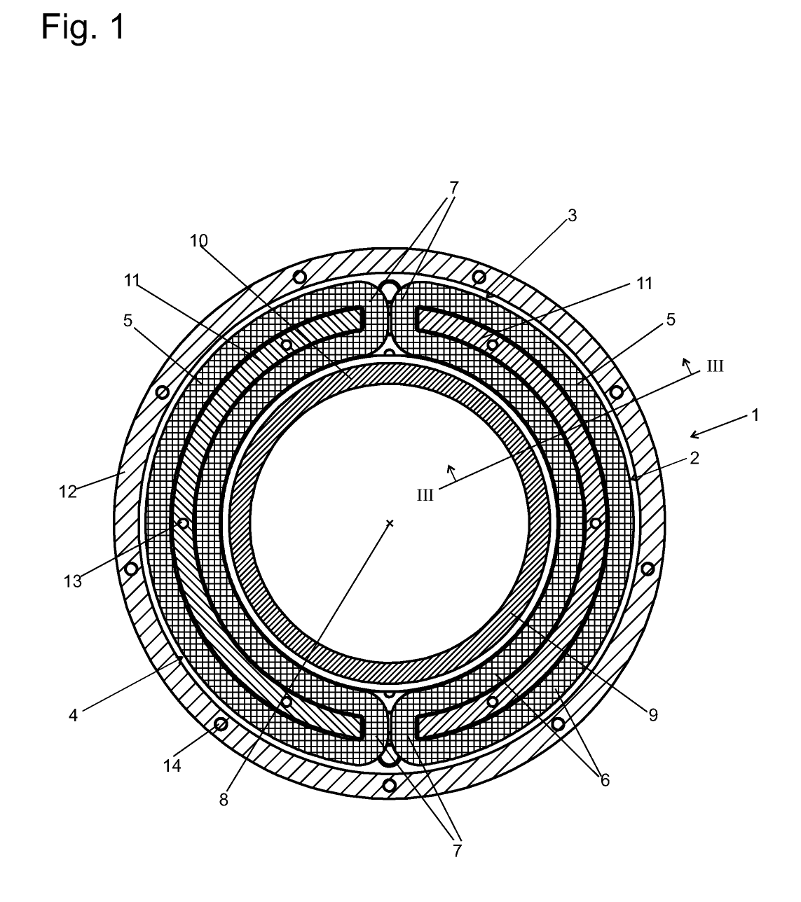

FIG. 1 illustrates a section through a device 1 for magnetically axially supporting a rotor. The device 1 comprises a magnetic thrust bearing 2 with two bearing branches 3, 4 which each comprise one substantially semicircular coil 5. Since the coils 5 naturally comprise a closed progression, two semicircular sections 6 result per coil 5 which are connected at both ends thereof via radially extending sections 7. The two bearing branches 3, 4 are arranged one after the other in the circumferential direction and opposite to each other with respect to an axis of rotation 8 in the center of the magnetic thrust bearing 2, wherein the sections 7 are substantially parallel to each other at the coil ends of the adjacent coils 5 of the bearing branches 3, 4. Between the bearing branches 3, 4 and/or at a radial inner side of the bearing branches 3, 4 the magnetic thrust bearing 2 comprises one single common, closed pole in the form of a pole ring 9. The single common pole ring 9 has a continuous circular ring-shaped cut face 10 and is arranged substantially concentrically to the coils 5, radially inside of the bearing branches 3, 4, wherein the center point of the cut face 10 is arranged on the axis of rotation 8. The bearing branches 3, 4 arranged one after the other in the circumferential direction surround the entire pole ring 9 and/or cover the entire angular range of 360° substantially completely. Since the two coils 5 are preferably of identical structure, the two bearing branches 3, 4 of the magnetic thrust bearing 2 are substantially identical and cover each approximately one half of the pole ring 9.

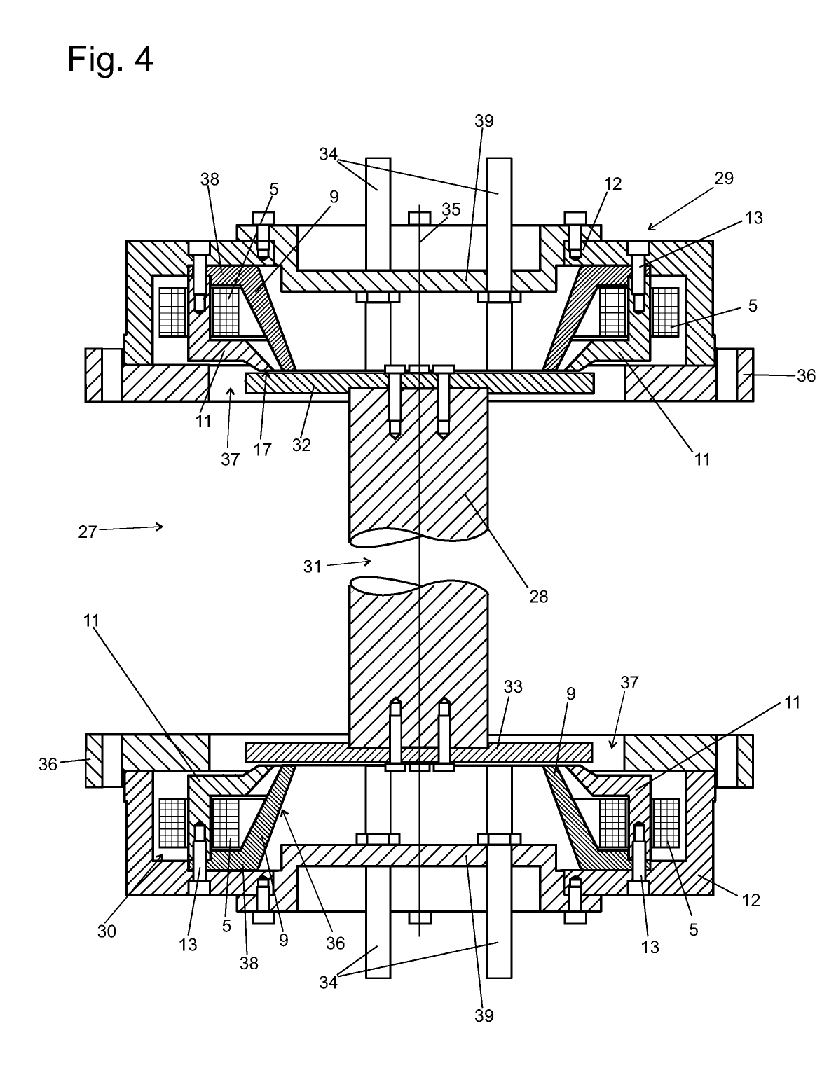

In the interior of the coils 5, substantially semicircular pole segments 11 are each arranged which substantially fill the coils 5, for instance, since the coils 5 are wound about the pole segments 11. The windings of the coils 5 are in the plane of illustration in the example shown, so that the magnetic field induced in the pole segments 11 when current flows through the coils 5 is oriented at least in sections parallel to the axis of rotation 8 (cf. FIG. 3). The pole segments 11 are parts manufactured separably from the common pole ring 9 which are in contact with the pole ring 9 in the assembled state of the magnetic thrust bearing 2 and which are preferably connected therewith (cf. FIG. 4). The magnetic thrust bearing 2 is surrounded by a sheath 12 (cf. FIG. 1) serving as a carrier and/or for the stable assembly and possibly for the shielding of magnetic stray fluxes. In the pole ring segments 11 and in the sheath 12, connection elements 13 and/or 14, for instance, screws, for assembly of the device 1 are provided in parallel to the axis of rotation and/or perpendicular to the drawing plane.

Since no magnetic material is arranged between the coils 5, a flux isolation between the bearing branches 3, 4 can be achieved by the successive arrangement of the bearing branches 3, 4 in the circumferential direction. Simultaneously, due to the common pole ring 9 an optimal azimuthal homogeneity of the magnetic flux density, i.e. an optimum homogeneity in the direction of rotation, can be achieved and hence losses from reversal of magnetism in the thrust bearing plate can be reduced.

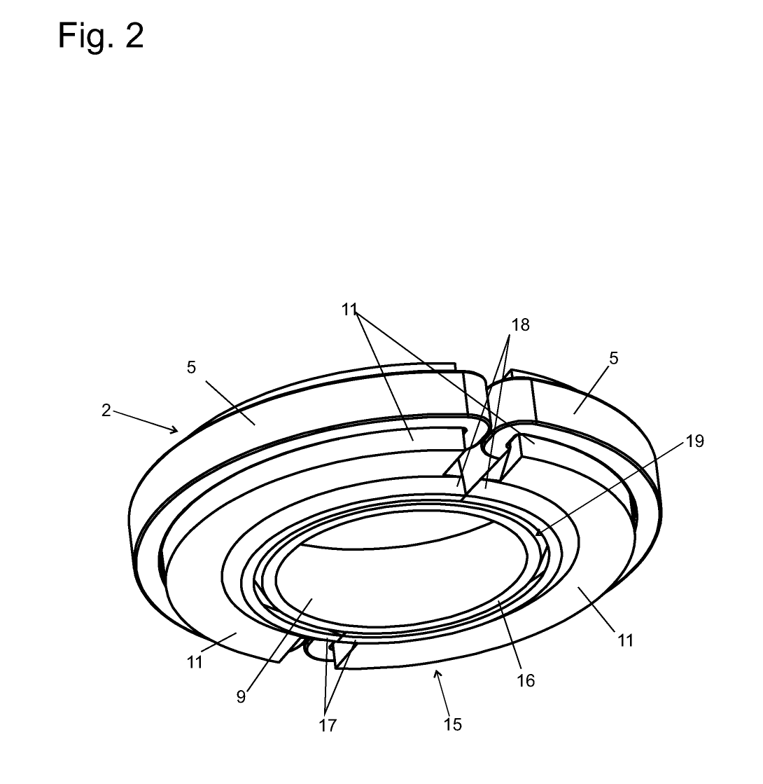

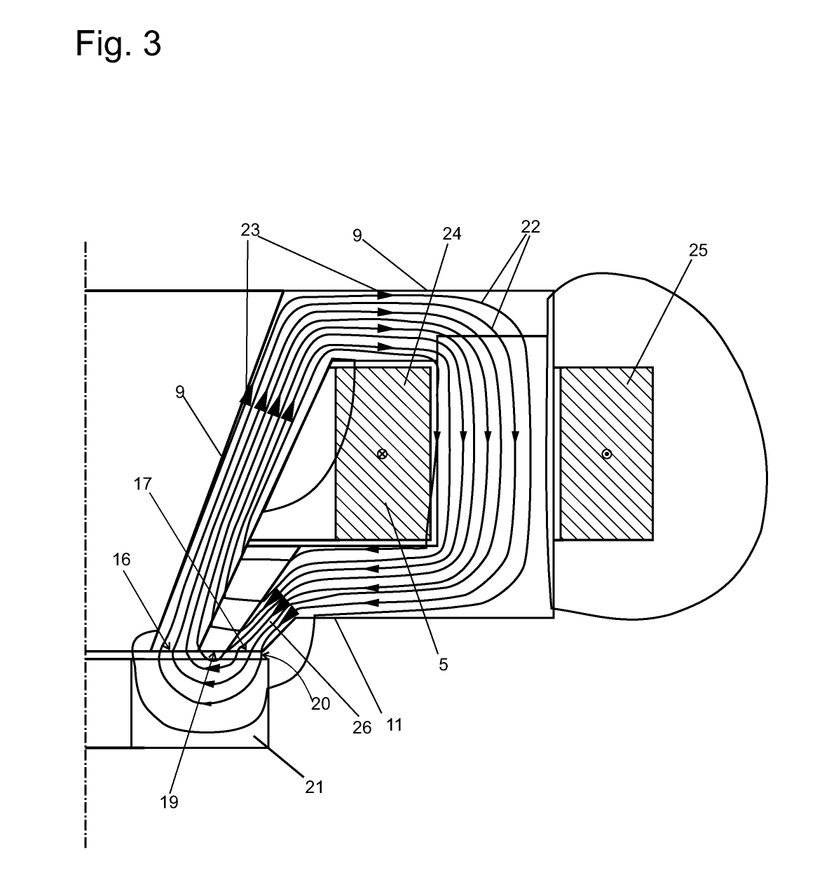

FIG. 2 illustrates a part of the device 1 pursuant to FIG. 1, wherein, for better visibility of the coils 5, i.e., the sheath 12 is not shown. At the bottom side 15 of the magnetic thrust bearing 2 which is visible here, the single circular ring-shaped pole surface 16 of the single common pole ring 9 can be recognized as well as the pole surfaces 17 of the two pole segments 11. The pole surfaces 17 of the pole segments 11 form a circular ring which is concentrical to the pole surface 16 of the pole ring 9 and which is interrupted only at the two abutting faces of the pole segments 11. Although the pole segments 11 are spaced apart in the region of the coils 5, as may be seen in particular by means of the cut face in FIG. 1, the pole surfaces 17 of the pole segments 11 directly adjoin each other in the circumferential direction in that the pole segments 11 comprise projections 18 projecting in the circumferential direction below the coils. A distance 19 is provided between the pole surface 16 of the pole ring 9 and the pole surfaces 17 of the pole segments 11, said distance in the illustrated example being larger than the distance 20 of the pole surfaces 16, 17 to a thrust bearing plate 21 (cf. FIG. 3). The pole segments 11 comprise a radius decreasing towards the respective pole surface 17, i.e. they extend below the coils 5 radially inwardly, towards the axis of rotation 8, and/or are shaped to converge frustoconically towards the pole surfaces 17. The common pole ring 9 comprises a radius decreasing across the entire height and/or is converging frustoconically across the entire height. Thus, it is achieved that the pole surfaces 16, 17 have a smaller radius and are smaller than the cut faces of the pole ring 9 and of the pole ring segments 11 in the area of the coils 5, as illustrated in FIG. 1. The pole surface 16 of the pole ring 9 is radially somewhat broader than the pole surfaces 17 of the two pole segments 11, so that the pole surface 16 of the pole ring 9 corresponds approximately to the sum of the pole surfaces 17 of the two pole segments 11.

FIG. 3 illustrates a radial cross-section of the magnetic thrust bearing 2 corresponding to the line III-Ill in FIG. 1 with a thrust bearing plate 21. A possible progression of magnetic field lines 22 is schematically drawn so as to illustrate the magnetic flux density. The field lines 22 correspond to the equipotential lines of the magnetic flux. The arrow size of the illustrated direction arrows 23 on the field lines is approximately proportional to the local flux density. In the direction of the magnetic field as illustrated, a current flows in the coil section 24 positioned radially inside, between the pole ring 9 and the pole segment and/or pole ring segment 11 in the direction of the drawing plane and in the coil section 25 positioned radially outside it flows out of the drawing plane. The magnetic field lines 22 are closed over the thrust bearing plate 21, so that it is magnetically attracted. Both the pole ring 9 and the lowermost section 26 of the pole segment 11 comprise a cross-section converging towards the pole surface 16 and/or 17, so that the flux density in the region of the pole surfaces 16, 17 is increased relative to the flux density in the region of the coil 5. Moreover, the radius of both pole bodies 9, 11 (as pole bodies the pole ring 9 and the pole segments 11 and/or in general all pole elements forming a magnet core are comprehensively referred to in the following) decreases towards the pole surfaces 16, 17, which additionally contributes to an increase of the flux density due to the decreasing circumference. Due to the relatively small pole surfaces 16, 17 and the small distance between the pole surfaces it is possible that the thrust bearing plate 21 has a correspondingly small radius and cross-section, and the mechanical loads acting in the case of high speeds can be reduced as compared to larger thrust bearing plates. On the other hand, due to the relatively low flux density in the region of the coils 5, it is possible to achieve less magnetization and thus, due to the relation between the flux density and the magnetic resistance which is non-linear with real soft-magnetic materials, a smaller magnetic resistance of the pole bodies 9, 11 and lower losses from reversal of magnetism, which is useful so as to reduce stray fluxes externally of the pole bodies 9, 11.

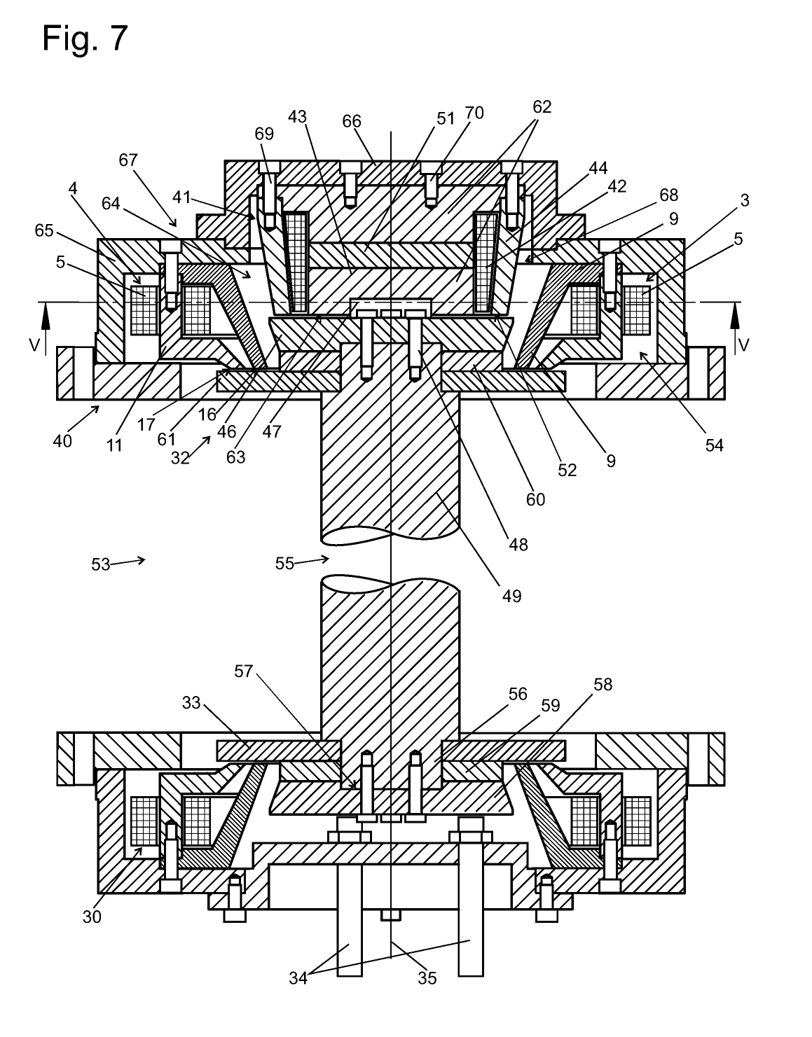

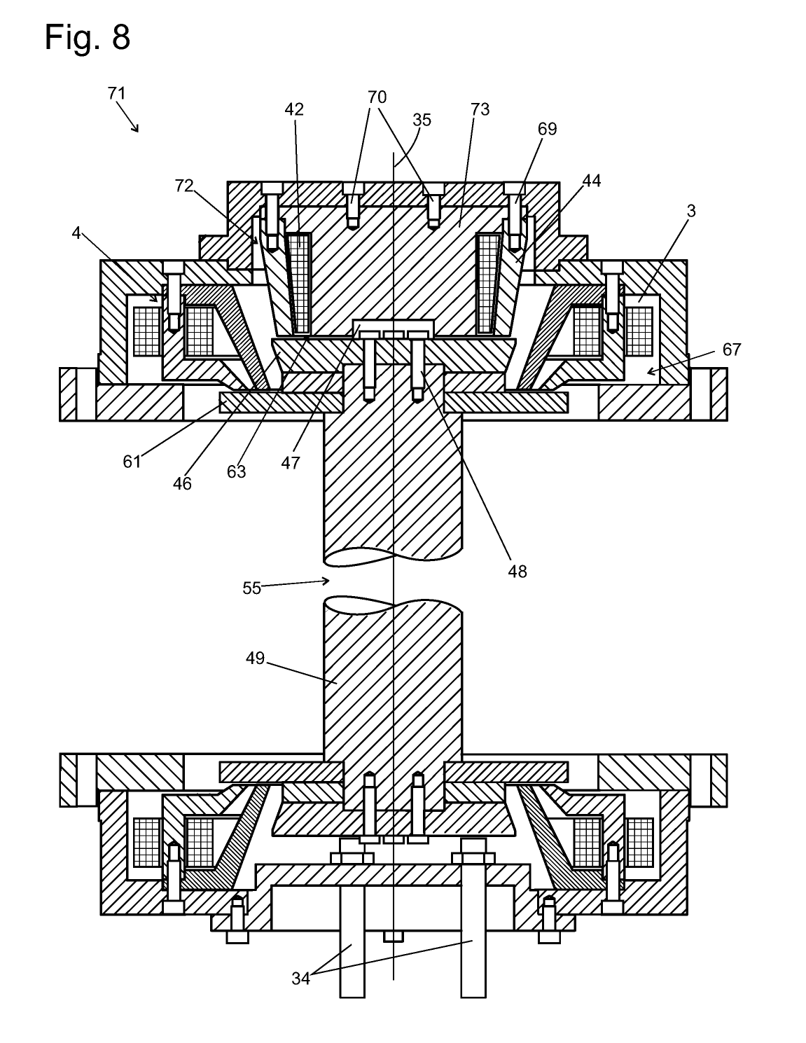

FIG. 4 illustrates a device 27 with a magnetically supported shaft 28. For the sake of convenience, only the magnetic thrust bearings 29, 30, but no radial bearings are illustrated. The shaft 28 is illustrated in a shortened manner, with a schematic interruption 31 (similar also in FIGS. 7, 8, etc.) so as to indicate that the length of the shaft 28 is not illustrated proportionally here. The magnetic thrust bearings 29, 30 each correspond to the device 1 illustrated in FIG. 1, each with two semicircular opposing coils 5 with a common pole ring 9 and separate pole segments 11. The magnetic thrust bearings 29, 30 each interact with a respective disk-shaped thrust bearing plate 32, 33, wherein the thrust bearing plates 32, 33 are arranged in the region of one respective end of the shaft 28 and are mounted for co-rotation with the shaft 28, for instance, screwed. It is, however, directly evident for the person skilled in the art that the shaft 28 may also be manufactured integrally with the thrust bearing plates 32, 33, for instance, completely of soft-magnetic iron and/or steel. Moreover, such shaft could also have a constant diameter, so that the shaft, instead of the stepped thrust bearing plates 32, 33, would only comprise one thrust bearing plate surface at each end and/or the shaft would correspond to one single, very thick thrust bearing plate.

The diameter of the thrust bearing plates 32, 33 is chosen such that the radius of the thrust bearing plates 32, 33 is somewhat larger than the outer radius of the pole surface 17 of the pole segments 11, so that the pole surfaces 17 of the pole segments 11 are completely covered by the thrust bearing plates 32, 33.

Radially inside of the ring-shaped magnetic thrust bearings 29, 30 distance sensors 34, for instance, eddy current sensors, are moreover arranged opposite to both thrust bearing plates 32, 33. The distance sensors 34 are arranged remote from the axis of rotation 35 and detect their own distance to the thrust bearing plate 32, 33 and thus the relative position of the thrust bearing plate 32, 33 and/or of the shaft 28 in the magnetic thrust bearings 29, 30. Starting out from the position measured, the coils 5 of the magnetic thrust bearings 29, 30 are controlled such that the rotor (illustrated partially only) remains and/or is centered between the magnetic thrust bearings 29, 30.

During operation, different thermal expansions of the rotor and the stator typically occur if the operating temperature changes. A heating of the rotor, for instance, due to the losses of a motor rotor, results in an extension of the rotor. On the other hand, an increase of the rotor speed leads to a reduction of the rotor length due to the centrifugal forces acting. In order to enable a stable axial position of the rotor despite these effects, the differential arrangement of the distance sensors 34 illustrated in FIG. 4 may preferably be used. In this connection, the axial distance of the rotor relative to the stator is detected at both rotor ends by means of the distance sensors 34, and the signals z₁ and/or z₂ thereof are, for instance, referred to as follows for the determination of the nominal position:

$${s}_{z , nom} = \frac{{z}_{1} + {z}_{2}}{2} \qquad ( 1 )$$

The magnetic thrust bearings 29, 30 are each arranged on a support unit 36 and surrounded by a sheath 12 which consists, for instance, of aluminum or non-ferromagnetic stainless steel. The support units 36 each comprise a circular recess 37 in which the respective thrust bearing plate 32, 33 is arranged to be substantially centered. The coils 5 and the pole bodies 9, 11 are each arranged on a side of the support unit 37 opposite to the shaft 28. The sheaths 12 extend like a lid over the magnetic thrust bearings 29, 30 and terminate with the support units 37. The pole bodies 9, 11 are connected with the sheaths 12, for instance screwed, wherein three respective screws 13 per pole segment 11 (cf. FIG. 1) penetrate the sheath 12 and the pole ring 9 and are anchored in the pole segments 11. Horizontal sections 38 of the pole rings 9 are each in full-faced contact with the inner side of the sheaths 12. The pole segments 11 are shaped such that the coils 5 can simply be plugged on and are fixedly applied on the pole segments 11 by means of the horizontal section 38 of the respective pole ring 9. Both sheaths 12 comprise a removable central part 39 which closes the respective sheath 12 centrally from the top and/or the bottom like a lid. The distance sensors 34 which extend inside the sheath 12 scarcely up to the respective thrust bearing plate 32, 33 are arranged in the central part 39. The nominal distance between the distance sensors 34 and the thrust bearing plates 32, 33 corresponds approximately to the nominal distance between the pole surfaces 16, 17 and the thrust bearing plates 32, 33.

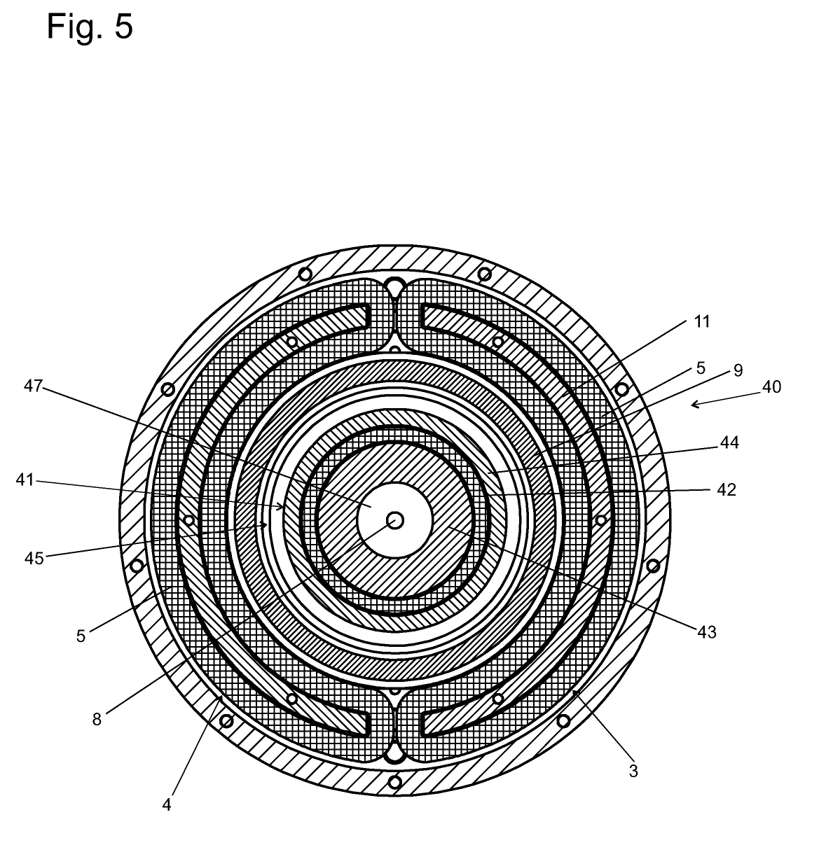

FIG. 5 illustrates a device 40 which is comparable to the device 1 in FIG. 1 and which comprises, in addition to the two opposite bearing branches 3, 4, a central bearing branch 41 with a circular ring-shaped coil 42 (in the following called ring coil 42). The section transverse to the axis of rotation 8 as illustrated corresponds to the line V-V in FIG. 7. The ring coil 42 of the central bearing branch 41 (in the following also called central bearing 41) surrounds a cylindrical inner pole 43 and is in turn surrounded by an outer pole ring 44 (not to be confused with the single common pole ring 9 of the opposite coils 5). A cylindrical inner contour of the ring coil 42 favors a simple manufacturing and minimizes possible eddy currents caused by rotation. A distance 45 is provided between the outer pole ring 44 of the ring coil 42 and the common pole ring 9 of the opposite outer bearing branches 3, 4 so as to achieve a flux isolation of the magnetic bearing branches 3, 4, 41. The magnetic circuit of the central bearing 41 formed by the ring coil 42, the inner pole 43 and the outer pole ring 44 is closed by an own plate part 46 of the thrust bearing plate 32 (cf. FIG. 7). The inner pole 43 is substantially massive and comprises a central recess 47 at a side facing the thrust bearing plate 32, said recess serving to receive fastening elements 48 projecting from the plate part 46 for fixing the plate part 46 to a shaft 49.

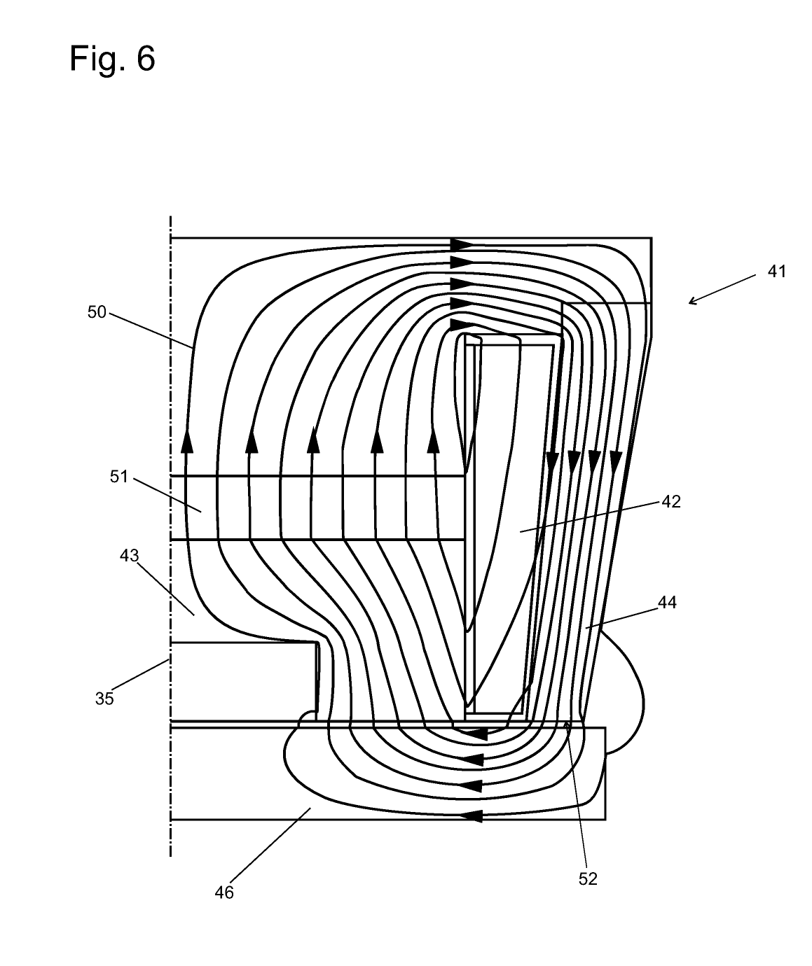

As may be recognized in FIG. 6 by means of the corresponding field lines 50 and/or equipotential lines, the central bearing 41 is a hybrid bearing which comprises, in addition to the electromagnet formed by means of the ring coil 42, a permanent magnet 51 (in the form of a permanent magnetic section 51) of the inner pole 43, and wherein the permanent magnetic flux overlaps the electromagnetic flux. The permanent magnetic section 51 and/or permanent magnet 51 generates a magnetic field which is oriented in parallel to the axis of rotation 35 and which may be increased or attenuated by the electromagnet. The permanent magnet 51 is preferably adapted such that its magnetic field alone supports the weight of the rotor with a nominal air gap. The magnetic force F_{G} applied by the permanent magnet 51 corresponds to the product of the mass mᵣₒₜₒᵣ of the rotor with the gravity acceleration g: F_{G}=mᵣₒₜₒᵣ·1 g. Thus, it is possible to achieve a particularly high energy efficiency and safety with a small space required. The design of the ring coil 42 is performed such that with a maximum current density in the ring coil 42 both the increase and the reduction of the static force F_{G} is possible in correspondence with a fraction of the total control force Fₜₒₜ which depends on the number n of the independently controllable thrust bearing branches 3, 4, 41 (Fₜₒₜ/n). The total control force Fₜₒₜ of all bearing branches 3, 4, 41 is preferably at least large enough to enable, in the case of failure of one bearing branch 3, 4, 41, a support and stabilization of the structure with the remaining bearing branches 3, 4, 41. The total control force Fₜₒₜ may, for instance, correspond to the three-fold of the gravity acting on the rotor, i.e. Fₜₒₜ=mᵣₒₜₒᵣ·(±3 g). In this case the control force of the central, hybrid bearing branch 41 results as F_{hybrid}=F_{G}+Fₜₒₜ/n, and with three independent bearing branches 3, 4, 41 as F_{hybrid}=F_{G}+Fₜₒₜ/3, which means that with a maximum current density in the ring coil 42 the force emanating from the permanent magnet 51 may either be doubled or be canceled, depending on the direction of the current. The exclusively electromagnetic, outer bearing branches 3, 4 are, in analogy to the electromagnetic part of the hybrid bearing, designed such that the respective control force results as F_{EM}=Fₜₒₜ/n.

In order to achieve a central bearing 41 as compact as possible and a small diameter of the associated plate part 46, the cross-section of the outer pole ring 44 and/or of the ring coil 42 of the hybrid bearing 41 converges towards the pole surface 52. Although the inner pole 43 of the ring coil 42 may basically also be designed to converge frustoconically towards the thrust bearing plate 32 and/or towards the plate part 46, a cylindrical shape is preferred due to the simpler manufacturing. In particular the outer pole ring 44 of the hybrid bearing 41 may taper radially towards the thrust bearing plate 32. It is to be understood that the compact structure described for the hybrid bearing 41 may also be used without permanent magnet 51, i.e. for a pure electromagnetic bearing branch (cf. FIG. 8).

FIG. 7 illustrates a device 53 with a magnetically supported shaft 49, wherein here, too—as in FIG. 4—only the magnetic thrust bearings 30, 54, but no radial bearings are illustrated for the sake of convenience and the shaft 49 is illustrated in a shortened manner, with a schematic interruption 55. In the lower end region 56 the shaft 49 comprises a tapered section on which the lower thrust bearing plate 33 is plugged and with the end surface 57 of which a sensor plate 58 is connected.

A distance ring 59 of non-magnetic material is arranged between the thrust bearing plate 33 and the sensor plate 58. Additionally, the shaft 49 may, at least in the region of the magnetic thrust bearings 30, 54, also consist of a non-magnetic material. In contrast to the device 27 illustrated in FIG. 4, the distance sensors 34 are here not arranged opposite to the thrust bearing plate 33, but opposite to the sensor plate 58 which is provided for this very purpose. The construction of the magnetic thrust bearing 30 is, however, identical otherwise, so that—in order to avoid repetitions—the above statements are referred to in this respect. The upper end of the shaft 49 is supported in a device 40 pursuant to FIG. 5, wherein the view in FIG. 5 corresponds to a sectional view along the line V-V in FIG. 7. In the device 40 illustrated here, an axially separated thrust bearing plate 32 is arranged at the upper end, which comprises two plate parts 46, 61 separated by a distance ring 60 of a non-magnetic material so as to achieve a decoupling of the magnetic fluxes and/or a flux isolation of the magnetic branches 3, 4, 41 and a larger distance between the stator units, i.e. in this case between the outer bearing branches 3, 4 and the inner, central bearing branch 41. Thus, possible flux density gradients during rotation due to the control currents in the hybrid bearing may be minimized. As may be seen here, the central bearing branch 41 is arranged coaxially partially in and/or overlapping the two outer bearing branches 3, 4. The larger one of the two plate parts 61 which is closer to the middle of the shaft 49 is magnetically supported by the outer bearing branches 3, 4 which follow each other in the circumferential direction, with opposite coils 5. The plate part 46 with a smaller diameter is arranged at the upper end of the shaft 49 and supported at a hybrid bearing forming the inner and/or central bearing branch 41, pursuant to FIG. 5 and FIG. 6. The hybrid bearing 41 consists of an outer pole ring 44 surrounding a ring coil 42 with converging cross-section. A massive cylindrical inner pole 43 which is divided in the direction of the axis of rotation 35 into two soft-magnetic sections 62 and the permanent magnetic section 51 in between is arranged in the ring coil 42. The inner pole 43 is in contact with the outer pole ring 44 at a side of the ring coil 42 which is opposite to the thrust bearing plate 32. At the side of the pole surfaces 52, 63 the pole bodies 43, 44 are separated up to the plate part 46 by the ring coil 42, i.e. one side of the ring coil 42 terminates substantially with the pole surfaces 52, 63.

A cavity 64 and/or distance 45 (cf. FIG. 5) is provided between the bearing branches 3, 4, 41 of the upper magnetic thrust bearing 54 (cf. FIG. 5) so as to avoid stray fluxes and transverse effects between the bearing branches 3, 4, 41. The distance 45 between the outer pole ring 44 of the central hybrid bearing 41 and the inner, common pole ring 9 of the outer bearing branches 3, 4 is larger than the distance between the two pole bodies 9 and 11 and/or 43 and 44 of each bearing branch 3, 4, 41. The distance between the bearing branches 3, 4, 41 and/or the radial cross-section of the cavity 64 decreases towards the plate parts 46, 61 since a plurality of bearing elements have a radius decreasing towards the plate parts 46, 61. The magnetic thrust bearing 54 moreover comprises a flux isolation between the outer bearing branches 3, 4 and the inner bearing branch 41, wherein a plate part 46 of the thrust bearing plate 32 which is separate from the remaining plate parts 61 is associated with the inner bearing branch 41.

Comparable to the differential arrangement of the distance sensors 34 described in connection with FIG. 4, a differential evaluation of the measured distances is also conceivable with arrangements with a hybrid bearing 41, for instance, with a distance sensor in the center of the hybrid bearing 41. For a minimum required actuating energy in the hybrid bearing 41 the nominal position for “normal” operating conditions is chosen such that the permanent magnetic branch and/or the permanent magnet 51 of the hybrid bearing 41 compensates for the weight force of the rotor (and possible static forces acting additionally on the rotor). In this respect, z₁ is referred to as a nominal size for control as long as the rotor is sufficiently remote from the stator at the lower end. For those cases of operation in which the desired minimum distance z_{b} between the rotor and the lower stator part is not given, the rotor is, for instance, brought in a position in which it has the same distance from the upper and the lower stators s_{z,nom}=s_{z,nom2}. Another possibility consists in the latter case in that the rotor is brought into that position s_{z,nom}=s_{z,nom2′} in which it comprises exactly z_{b} as a distance with respect to the lower stator. Thus, a lower static current through the coil 42 is required in the hybrid bearing 41 (cf. Equations (2) to (4)).

$$\begin{matrix}{s}_{z , nom 1} = {z}_{1} for {z}_{2} \geq {z}_{b} with & ( 2 ) \\ {s}_{z , nom 2} = \frac{{z}_{1} + {z}_{2}}{2} for {z}_{2} < {z}_{b} or & ( 3 ) \\ {s}_{z , nom {2}^{′}} = \frac{{z}_{1} + {z}_{2} - {z}_{b}}{2} for {z}_{2} < {z}_{b} & ( 4 )\end{matrix}$$

The sheath arrangement 65, 66 of the device 40 is divided into a radially outer sheath 65 for supporting and possibly for shielding the segment bearing 67 formed by the outer bearing branches 3, 4 and a radially inner sheath 66 for supporting and possibly for shielding the hybrid bearing 41. The inner sheath 66 is arranged in a central opening 68 of the outer sheath 65 and tops it correspondingly. The height of the device 40, i.e. the extension in the direction of the axis of rotation 35, is largest in the region of the hybrid bearing 41 since, on the one hand, the plate part 46 supported at the hybrid bearing 41 is arranged on the shaft 49 to be axially displaced from the plate part 61 supported at the segment bearing 67 and, on the other hand, the hybrid bearing 41 in the direction of the axis of rotation 35 is higher in the illustrated example than the segment bearing 67. Just as the common pole ring 9 of the segment bearing 67 is connected with the inner sheath 66, the inner pole 43 of the hybrid bearing 41 is connected, in particular screwed, with the inner side of the outer sheath 66. In addition to the connections 69 radially outside of the ring coil 42 which connect the sheath 66 with the inner pole 43 and the outer pole ring 44, connections 70 are provided approximately at half the radius of the inner pole 43. These additional connections 70 serve to transfer the load of the rotor which is, due to the permanent magnet 51, always largely supported by the hybrid bearing 41, as directly as possible to the sheath 66 so as to keep the mechanical strain of the pole bodies 43, 44 low.

FIG. 8 illustrates a device 71 which is similar to that of FIG. 7, with the difference that here a central bearing branch and/or central bearing 72 without a permanent magnet 51 is used. The bearing forces accordingly always have to be exerted by the electromagnetic bearing branches 3, 4, 72. For minimizing rotation losses due to reversal of magnetism in the rotor part, preferably only the central bearing 72 is active with small forces required. As compared to the device 53 described before, this results in a lower efficiency of the central bearing 72, but lower manufacturing costs are enabled instead since the supporting inner pole 73 of the central bearing 72 does not comprise a permanent magnetic section. The remaining structure is identical to the device 53 described before, so that is is referred to the above statements in order to avoid repetitions.

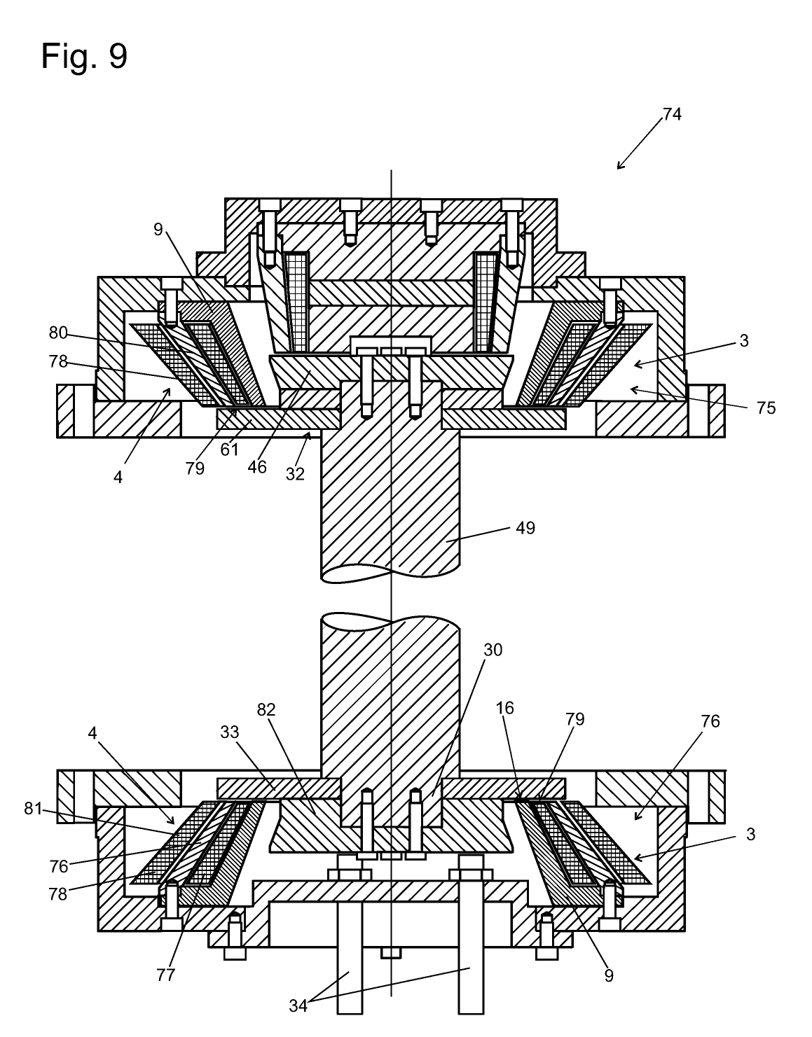

The device 74 illustrated in FIG. 9 has, with respect to functioning, also much similarity with the device 53 described in connection with FIG. 7. However, the outer bearing branches 3, 4 of the magnetic thrust bearings 75, 76 have a different geometrical construction. Only the common pole ring 9 which forms the radially inside, common pole is unchanged. The radially inner sections 77 of the coils 78 following each other are, across the entire height of the pole ring 9 up to the thrust bearing plate 33 and/or up to the plate part 61, in contact with the radial outer side of the respective pole ring 9, and the end faces 79 of the coils 78 at the side of the thrust bearing plate 33 and/or of the plate part 61 terminate with the pole surface 16 of the pole ring 9. Additionally, the cross-section of the coils 78 converges towards the respectively associated thrust bearing plate 33 and/or the plate part 61, wherein the dimension in the radial direction is smaller than the dimension in the axial direction. Pole ring segments 80 having a decreasing radius and a converging cross-section are arranged in the inside of the coils 78, wherein the cross-section of the pole ring segments 80 corresponds approximately to that of the radially inner coil section 77. The same applies for the radially outer sections 81 of the coils 78, so that the coils 78 and the pole bodies 9, 80 in the radial cross-section extend away from the thrust bearing plate 33 and/or from the plate part 61 in a fan-shaped manner, wherein respectively adjacent side faces of a pole body 9, 80 or of a coil section 77, 81 in the radial cross-section are not parallel, but also divergent.

The lower magnetic thrust bearing 76 is designed symmetrically to the outer bearing branches 3, 4 of the upper magnetic thrust bearing 76 and differs from the lower magnetic thrust bearing 30 described in connection with FIG. 7 by the fact that the sensor plate 82 is in contact with the thrust bearing plate 33. In this case, no distance ring is provided between the sensor plate 82 and the thrust bearing plate 33.

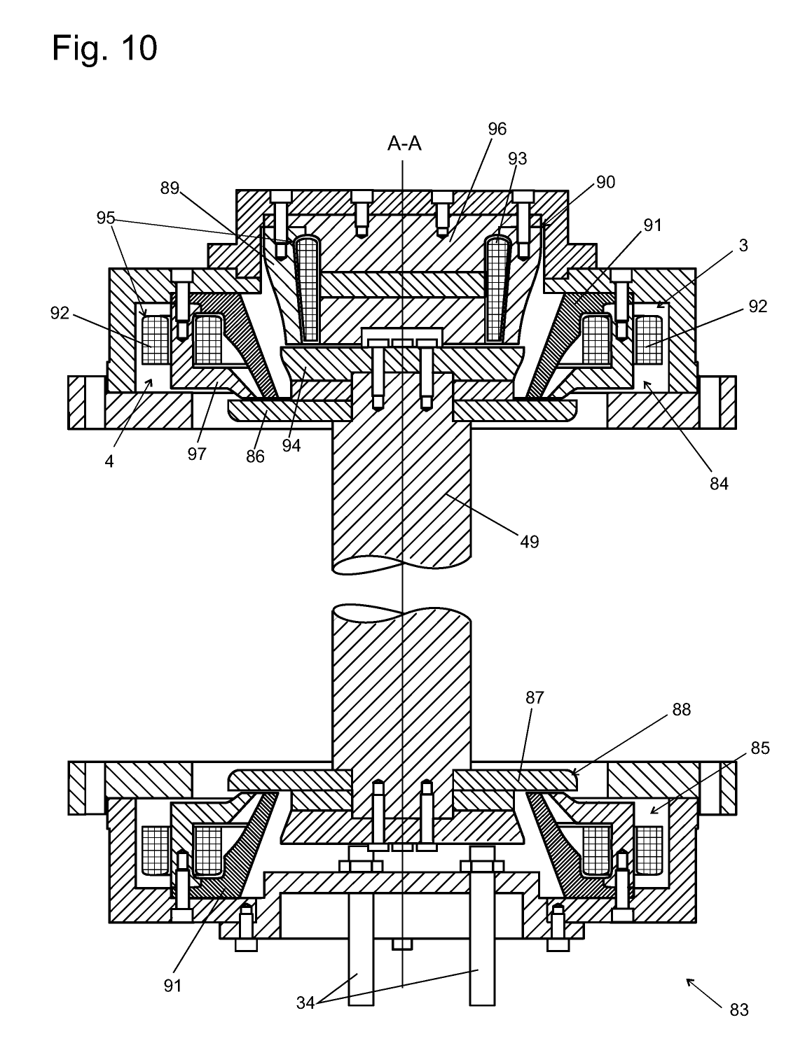

A further variant of a device 83 with a shaft 49 supported magnetically on magnetic thrust bearings 84, 85 in accordance with the invention is illustrated in FIG. 10. The elements and the basic structure of the magnetic thrust bearings 84, 85 correspond substantially to the devices 27 and 53 described in connection with FIG. 4 and FIG. 7, so that only the differences will be dealt with in this place and the above statements are referred to otherwise. The plate parts 86, 87 supported at the outer bearing branches 3, 4 comprise at a side facing the shaft 49, a rounded outer edge 88 each. The side faces at the radially outer sides of the outer pole ring 89 of the inner and/or central bearing branch 90 of the upper magnetic thrust bearing 84 and of the common pole rings 91 of the outer bearing branches 3, 4 deviate from a frustoconical shape and have a curved progression in cross-section, i.e. the contour of the pole bodies 89, 91 mentioned is not just composed of straight lines, but also follows higher-order curves. Accordingly, the pole bodies 89, 91 are not strictly linearly converging, but comprise a non-linear tapering. Moreover, both the opposite coils 92 of the outer bearing branches 3, 4 and the ring coil 93 of the central bearing branch 90 have rounded edges 95 at a side facing away from the plate parts 86, 87, 94, wherein the adjacent pole bodies 89, 91, 96, 97, i.e. the outer pole ring 89, the common pole rings 91, the inner pole 96 of the central bearing 90, and the pole ring segments 97 are adapted to the rounded progression, so that no additional cavities are produced between the coils 92, 93 and the pole bodies 89, 91, 96, 97. Likewise, the contact face between the pole ring segments 97 and the respective common pole ring 91 is rounded. The roundings illustrated and described, and/or the avoiding of edges advantageously supports the minimizing of stray fields in that the profiles of the elements which are part of a magnetic circuit are adapted to the progression of the magnetic flux lines.

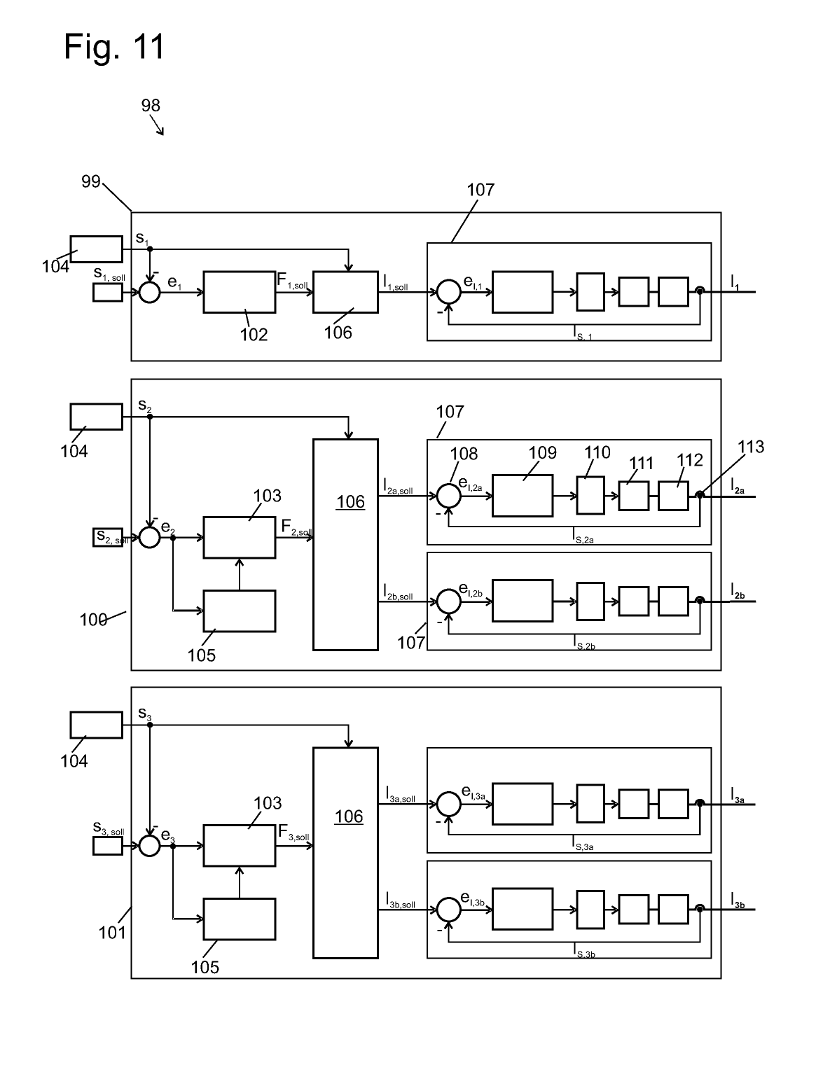

FIG. 11 comprises a schematic block diagram 98 for illustration of a control circuit and/or a control method for controlling one or a plurality of magnetic thrust bearings for stabilization of a rotor, for instance, in a device 53, 71, 74, 83 pursuant to any of FIGS. 7 to 10. The block diagram 98 illustrates three independently operating, voltage-supplied regulating units 99, 100, 101, wherein the first regulating unit 99 provides one single regulated output current I₁ while the two other regulating units 100, 101 each provide two independently regulated output currents I₂ₐ, I_{2b}, I₃ₐ, I_{3b}. A regulating unit 99 associated preferably with a central bearing branch, in particular a central hybrid bearing, may be equipped with a PID position regulator 102 for the sake of convenience and robustness, the other regulating units 100, 100 which are, for instance, associated with two respective outer bearing branches 3, 4 may be equipped with a PD position regulator 103 with a subordinate P current regulator, as will be explained in detail in the following. The regulating units 100, 101 with two output currents are preferably adapted to control two opposing bearing branches 3, 4. The regulating units 99, 100, 101 control the output currents I₁, I₂ₐ, I_{2b}, I₃ₐ, I_{3b} as a function of a signal S₁, S₂, S₃ of a respective position sensor 104 and a predetermined nominal value S_{1,nom}, S_{2,nom}, S_{3,nom}(S_{1,soll}, S_{2,soll}, S_{3,soll}) of the respective signal S₁, S₂, S₃, for instance, the distance between the position sensor 104 and a sensor plate and the predetermined, desired distance. Further sensors for detecting the actual state, for instance, current sensors or temperature sensors, along with the nominal values to be used may, however, also be connected with the regulating units 99, 100, 101. The position sensors 104 are preferably arranged and evaluated in a differential sensor arrangement, as already explained in detail in connection with FIG. 4 and FIG. 7.

The sensor signals S₁, S₂, S₃ may be transferred to analog digital converters after filtering and signal adaptation (e.g. anti-aliasing filter, level and offset adaptation). The appropriate signal processing may, for instance, be integrated directly in a micro controller which may also integrate some of the following units. The regulating unit 99 (the same applies in analogy to the other regulating units 100, 101, which is expressed by the index i which assumes the value 1, 2 or 3, depending on the regulating unit considered) determines a position deviation eᵢ and transfers same to a position regulator 102, 103. Moreover, in the two other regulating units 100, 101 the position deviations eᵢ are evaluated in the threshold value switches 105. The two threshold value switches 105 are connected with the position regulators 103 of the respective regulating unit 100, 101 and are adapted to deactivate and activate the position regulators 103. This means that, if a threshold value pre-configured in a threshold value switch 105 has not been exceeded, the respectively associated position regulator 103 operates as if the position deviation eᵢ were zero, i.e. F_{i,nom}=0.

The position regulator 102 and/or 103 (if the threshold value of the threshold value switches 105 has been exceeded) determines a required force F_{i,nom} from the position deviation eᵢ obtained so as to return the rotor in a nominal position if required. From this force F_{i,nom} and the measured position Sᵢ a conversion unit 106 determines the corresponding nominal currents I_{1a,nom}, I_{1b,nom} for the coils of the magnetic thrust bearing. For this purpose the conversion unit 106 uses a characteristic diagram Iᵢ (F_{i,nom}, Sᵢ) of the coils and/or of the bearing branches which indicates the current as a function of the desired action of force and the position of the rotor. The characteristic diagram Iᵢ (F_{i,nom}, Sᵢ) may, for instance, be determined empirically in advance or be calculated from the characteristic coil data and the pole shapes. The nominal currents I_{1a,nom}, I_{1b,nom} determined this way are transmitted to independent current regulating units 107 which are associated to a respective output current I₁ and/or I₁ₐ, I_{2b} and/or I₃ₐ, I_{3b} The current regulating units 107 comprise a difference unit 108, a current regulator 109, a limiter 110, a pulse width modulator 111, a power converter 112 with H-bridge, and a current sensor 113. The current sensor 113, in particular a Hall effect sensor, Hall effect sensor pursuant to the flux compensation principle, or a magneto-resistive sensor, measures e.g. in the case of the regulating unit 104 an output current I₂ₐ of the current regulating units 107, so that the difference unit 108 can determine a current deviation e_{I,2a} between the output current I₂ₐ and the nominal current I_{2a,nom}. The determined current deviation e_{I,2a} is used by the current regulator 109 for controlling the pulse width modulator 111, wherein the interconnected limiter 110 takes care that, for instance, a particular maximum current cannot be exceeded. The pulse width modulator 111 generates in a per se known manner a switch signal controlling the output current of the power converter 112. The regulating unit 99 with a single output current I₁ for a single coil operates substantially identically, wherein the conversion unit 106 only determines a nominal current I_{1,nom} and the regulating unit 99 accordingly comprises only one current regulating unit 107.

The regulating units 99, 100, 101 are each part of an thrust bearing branch regulating system, wherein in the ideal case each regulating system comprises an independent voltage supply and its own sensors, in particular its own position sensor 104. As already explained in connection with the design of the bearing forces, the bearing branches controlled by the independent regulating systems are preferably balanced such that each bearing branch may apply the same maximum and/or minimum bearing force. In the normal case of operation, for instance, only one hybrid bearing associated with the regulating unit 99 may be used, wherein minor disturbance forces may be corrected without the remaining bearing branches, in particular without possible segment bearings. In this connection a monitoring of particular operating conditions, for instance, with respect to the exceeding of a predefined maximum deflection and/or deflection speed, for example in the form of the threshold value switches 105 may be provided, and an automatic activation of the respective bearing branch on occurrence of such an operating condition may be provided.

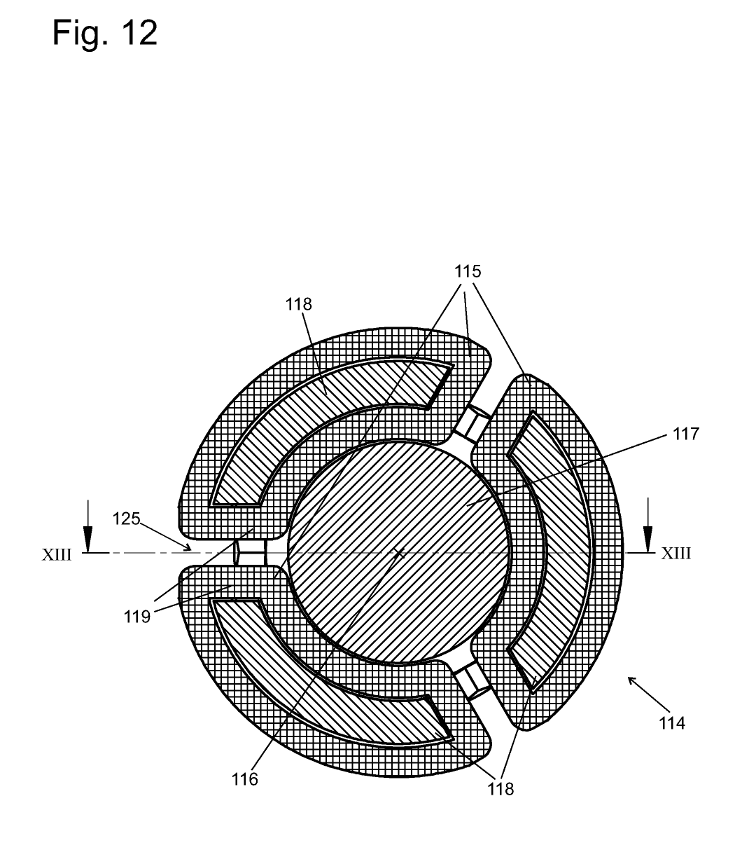

FIGS. 12 to 14 illustrate an advantageous three-segment hybrid bearing 114. As may be seen in particular in the cross-section perpendicular to the axis of rotation—pursuant to FIG. 12—the three coils 115 of the hybrid bearing 114 which each form an independent bearing branch are arranged to be positioned opposite to each other with respect to the axis of rotation 116 and/or one after the other in the circumferential direction and surround a common pole body 117. This achieves a flux isolation of the bearing branches. The section of the pole body 117 which is arranged between the coils 116 is cylindrical and thus comprises a circularly closed circumference, wherein the longitudinal axis of the cylinder is substantially arranged on the axis of rotation 116 of the rotor. Pole segments and/or pole ring segments 118 are arranged in the inside of the coils 115, the contour of which at a radial inner side and a radial outer side corresponds to concentric circular arcs whose common center point is arranged on the axis of rotation 116. Accordingly, the windings of the coils 115 also follow a circular arc-shaped progression which is closed by radial connecting sections 119 at the end faces of the pole ring segments 118 (cf. FIG. 12).

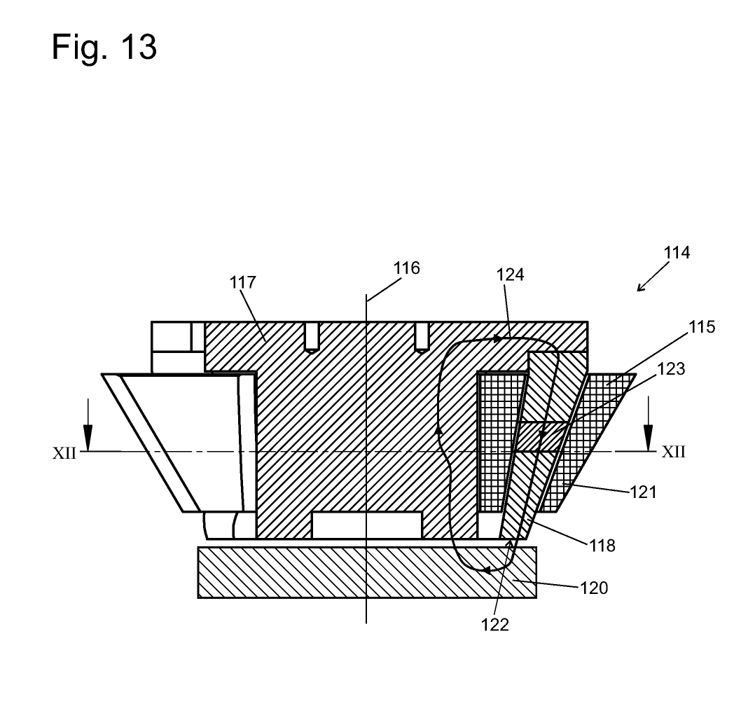

In particular in the cross-section along the axis of rotation 116 pursuant to FIG. 13 (corresponding to the line XIII-XIII in FIG. 12) it can be recognized that both the coils 115 and the pole ring segments 118, for instance, comprise a cross-section e.g. converging towards a thrust bearing plate 120. The inner face of each coil 115 is preferably arranged to be in contact with the outer face of the pole ring segment 118, so that the pole ring segment 118 and the radially outer coil section 121 comprise a radius decreasing towards the thrust bearing plate 120. The radius of the thrust bearing plate 120 is somewhat larger than the outer radius of the pole surface 122 of the pole ring segment 118 and is thus smaller than the radius of the pole ring segment 118 in the region of the coil 115. The pole ring segment 118 comprises a permanent magnet 123, so that the hybrid bearing 114 produces a magnetic field even if the coils 115 are not fed with current. An equipotential line 124 schematically illustrates the progression of the magnetic circle which is closed by the thrust bearing plate 120. In contrast to earlier illustrations, the arrow sizes are here not proportional to the magnetic flux density. The line XII-XII in FIG. 13 shows the axial position of the cross-section illustrated in FIG. 12.

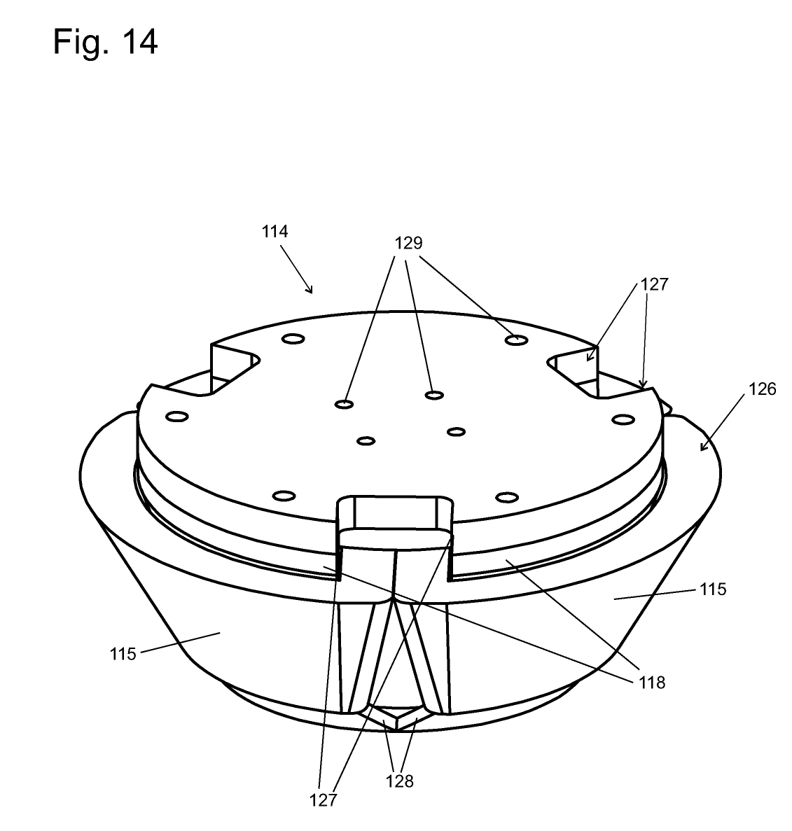

The diagrammatic illustration of the three-segment hybrid bearing 114 in FIG. 14 shows the reason for the distance 125 illustrated in FIG. 12 between the coils 115 in the circumferential direction: Due to the converging coil cross-section the coils 115 below their upper side 126 do not fill the entire distance between the end faces 127 of the pole ring segments 118 which are arranged in parallel to the axis since this distance depends on the maximum coil cross-section at the upper side 126. In order to produce a preferably homogeneous magnetic field in the circumferential direction despite this distance and to avoid field gradients in the circumferential direction, the pole ring segments 118 comprise a projection 128 below the coil 115, i.e. in a region between the coil 115 and the pole surface 122, in the circumferential direction. The length of the projection 128 corresponds approximately to the distance between the end faces 127 of the pole ring segments 118, so that, with respect to small flux gradients in the rotating thrust bearing plate no or just a minimum gap is produced between the pole surfaces 122, and/or a preferably large distance is useful with respect to the best possible isolation of the fluxes of the magnetic branches, wherein a compromise between the achieved flux isolation and the avoidance of losses from reversal of magnetism is chosen. At a side of the common pole body 117 which faces away from the thrust bearing plate 120, assembling bores 129 are provided for fastening the hybrid bearing 114 to a sheath 130.

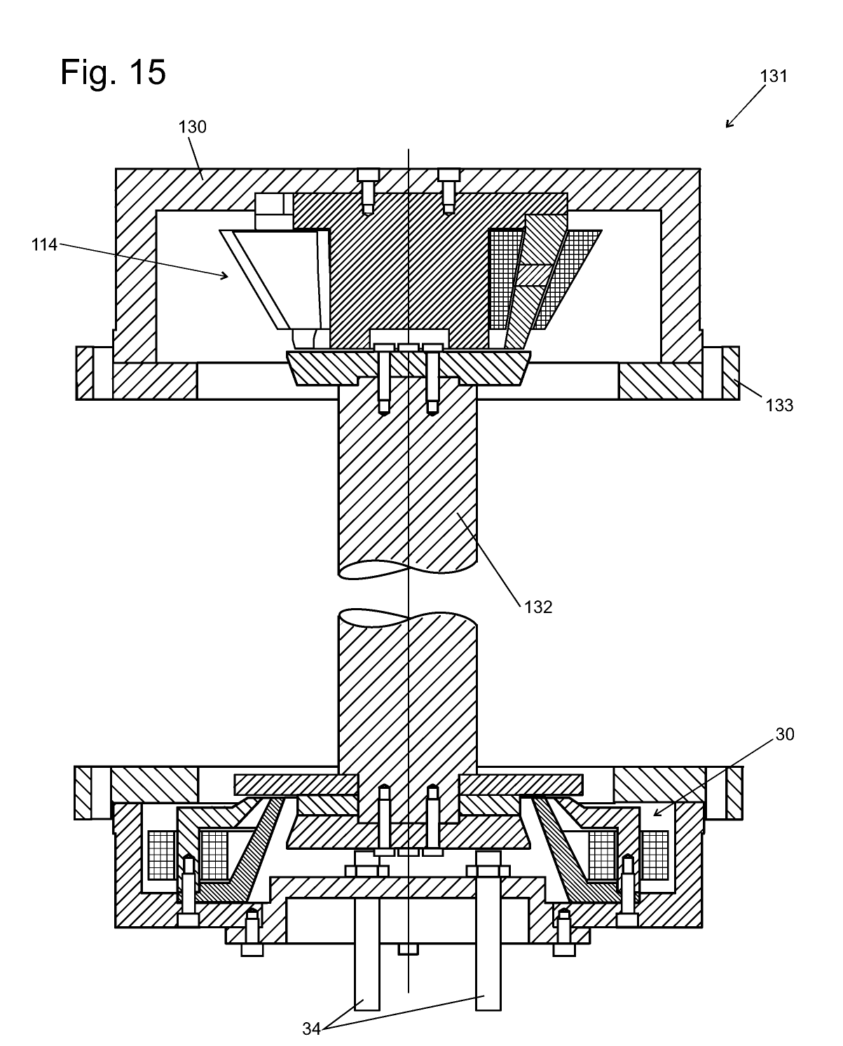

FIG. 15 illustrates a device 131 with a magnetically supported shaft 132 with two magnetic thrust bearings 30, 114. The lower magnetic thrust bearing 30 corresponds to an arrangement already described in connection with FIG. 4, so that earlier descriptions are referred to in this respect. The upper magnetic thrust bearing 114 is a three-segment hybrid bearing 114 pursuant to FIGS. 12 to 14 which is connected with a sheath 130, wherein the sheath 130 is arranged on a support unit 133. In this variant the hybrid bearing 114 is adapted to support the static load and to control accelerations of the rotor, wherein the maximum negative force acting by the bearing on the rotor results with a complete compensation of the permanent magnetic flux, in the best possible case thus corresponding to −1 g effective acceleration to the rotor. For larger negative accelerations the lower magnetic thrust bearing 30 is additionally activated. If the absolute value of the acceleration to be compensated by means of the thrust bearing is smaller than the gravity acting on the rotor, the lower magnetic thrust bearing 30 may be omitted.

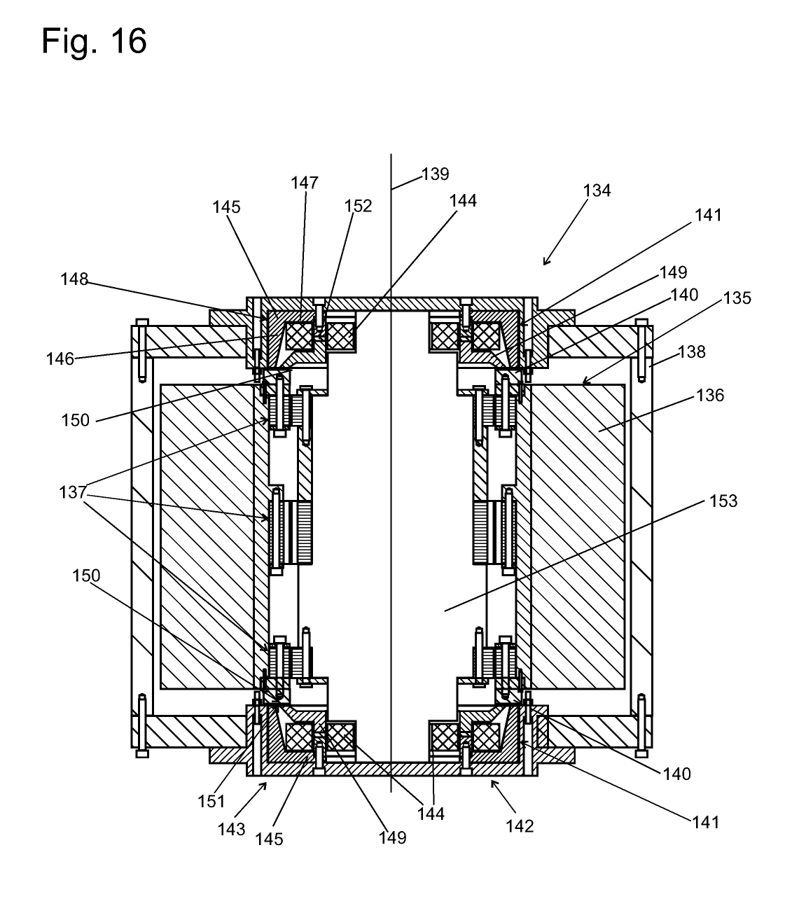

FIG. 16 illustrates a device 134 with a magnetically supported outer rotor construction 135. The flywheel mass rotor 136 is supported in a per se known manner on a plurality of radial magnetic bearings 137 and enclosed in a sheath 138. At the outer ends of the rotor 136 along the axis of rotation 139 a respective circular ring-shaped thrust bearing plate 140 is arranged which is in magnetic interaction with a magnetic thrust bearing 141 which has a structure that is basically similar to that of the bearing 29 pursuant to FIG. 4. The two magnetic thrust bearings 141 are of identical structure. Each magnetic thrust bearing 141 comprises two bearing branches 142, 143 arranged to be opposite to each other with respect to the axis of rotation 139 and/or one after the other in the circumferential direction, with one coil 144 each and only one single common pole 145 which is arranged radially outside of the bearing branches 142, 143. Accordingly, no magnetic material is positioned between the bearing branches 142, 143, so that a flux isolation of the bearing branches 142, 143 is achieved. The common pole 145 is circular ring-shaped with an L-shaped cross-section, wherein a side wall 146 is arranged substantially parallel to the axis of rotation 139 and a base 147 is arranged substantially perpendicular to the axis of rotation 139. The side wall 146 comprises a cross-section converging towards the thrust bearing plate 140, wherein the outer side 148 is substantially cylindrical. The coils 144 are arranged at the radial inner side of the side wall 146 and are interspersed by pole segments 149. The pole segments and/or pole ring segments 149 extend from the base 147 of the common pole 145 in parallel to the axis of rotation 139 through the coil 144 up to the opposite side where they expand radially outwardly and finally branch off to the thrust bearing plate 140 under approximately 45° so as to form a circular ring segment-shaped pole surface 150 which is arranged concentrically inside and in a plane with a pole surface 151 of the common pole 145. A section 152 of the pole ring segments 149 is permanent magnetic and/or comprises a permanent magnet and thus produces a constant magnetic field even without current. Due to the profile of the common pole 145 and in particular of the pole ring segments 149 the thrust bearing plate 140 may have a small radial extension and surface perpendicular to the axis of rotation 139, which is in particular smaller than the side faces of the coils 144 perpendicular to the axis of rotation 139. The coils 144 in this example have an approximately square cross-section, which enables easy manufacture. The small surface of the thrust bearing plate 140 enables altogether particularly small dimensions, in particular a comparatively large inner diameter, and thus enables easy assembling, on the one hand, and a large outer diameter of the inner mandrel 153, on the other hand, so that the stiffness thereof increases and higher rotor speeds below the first natural frequency of the mandrel become possible.

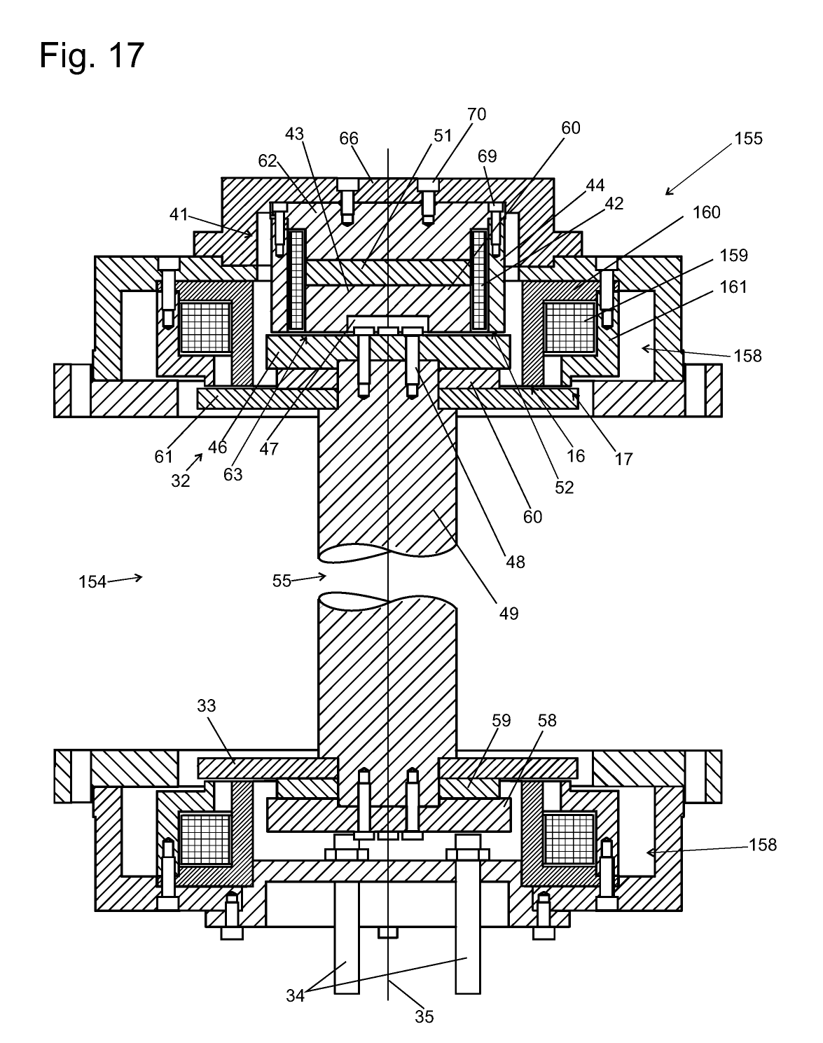

FIG. 17 illustrates a device 154 whose basic structure is somewhat similar to the device 53 illustrated in FIG. 7, so that comparable parts are designated with the same reference numbers in the following. The thrust bearing plate 32 at the upper end of the shaft 49 comprises two axially separated plate parts 46, 61 which are supported in a magnetic thrust bearing 155. Between the plate parts 46, 61 there is arranged a distance ring 60 of a non-magnetic material whose diameter is somewhat smaller than that of the smaller one of the adjacent plate parts 46. The side faces of both plate parts 46, 61 are cylindrical and in parallel to the axis of rotation 35. The magnetic thrust bearing 155 comprises two bearing branches 156, 157 which are arranged coaxially partially in each other or overlapping. The inner bearing branch 156 is formed by a hybrid bearing 41 and the outer bearing branch 157 is formed by a ring-shaped bearing, in the following called ring bearing 158. Accordingly, the upper, smaller plate part 46 at the thrust bearing plate 32 is associated with the hybrid bearing 41. The hybrid bearing 41 consists of an outer pole ring 44 surrounding a ring coil 42 with a rectangular cross-section. In the ring coil 42 there is arranged a massive cylindrical inner pole 43 which is divided in the direction of the axis of rotation 35 into two soft-magnetic sections 62 and a permanent magnet 51 therebetween. The inner pole 43 is in contact with the outer, cylindrical pole ring 44 at a side of the ring coil 42 which is opposite to the plate part 46. At the side of the pole surfaces 52, 63 the pole bodies 43, 44 are separated by the ring coil 42 up to the plate part 46, i.e. a side of the ring coil 42 which faces the thrust bearing plate 32 terminates substantially with the pole surfaces 52, 63 of the hybrid bearing 41.

The larger one of the two plate parts 61 is supported at the ring bearing 158 comprising a single, concentric ring coil 159. The ring coil 159 surrounds an inner pole ring 160 and is in turn surrounded by an outer pole ring 161, wherein the two pole rings 160, 161 are connected with each other in an operative state of the ring bearing 158. Due to the concentric, completely circular ring-shaped structure of the ring bearing 158 the magnetic field produced for supporting the associated plate part 61 comprises a continuously azimuthal homogeneous flux density, and accordingly a support almost free of eddy current can be achieved.

The profiles of the pole rings and/or pole shoes 160, 161 comprise in this example no lines inclined relative to the axis, but exclusively parallel or perpendicular lines, i.e. generally rectangular cross-section shapes exist. This does not change anything about the basic functionality of the bearing illustrated, and the advantage of such pole shoes 160, 161 consists predominantly in the simple and cost-efficient manufacturing. In analogy to the device 53 illustrated and described in FIG. 7, the magnetic thrust bearing 155 also comprises a flux isolation between the bearing branches 156, 157 which is achieved by the complete separation of the bearings 41, 158 and simultaneously division of the thrust bearing plate 32 into the plate parts 46, 61 as well as the magnetic separation of the plate parts 46, 61. As becomes particularly clear from FIG. 17, the inner diameter of the outer bearing branch 167 and/or of the ring bearing 158 is larger than the outer diameter of the plate part 46 associated with the inner bearing branch 156, so that easy disassembling of the device 154 is achieved.

Even if the specific pole shapes have only been described together with a flux isolation between two bearing branches in the preferred embodiments illustrated here, the person skilled in the art can absolutely recognize directly that a part of the advantages of the present invention can also be achieved with only one bearing branch. It is in particular the advantageously small dimensions of the thrust bearing plates that can be achieved by means of the specific pole shapes described here, irrespective of whether one or a plurality of bearing branches exist. Accordingly, the invention relates to the compact pole shapes even if only one single coil is used. In particular, those pole shapes of magnetic thrust bearings are meant in a quite general way which comprise a cross-section converging linearly or non-linearly in the direction of a thrust bearing plate and/or a radial pole distance decreasing from a coil to a thrust bearing plate.

1.-15. (canceled)

16. A device for magnetically axially supporting a rotor comprising a thrust bearing plate connected to the rotor, in a magnetic thrust bearing having at least two independently controllable bearing branches which each comprise at least one coil, wherein magnetic flux isolation of the bearing branches is provided, wherein the flux isolation consists in that at least two of the bearing branches are arranged one after another in a circumferential direction and have a single common pole which has a circularly closed circumference, a center point of which is arranged on an axis of rotation of the rotor, wherein the coils surround pole segments connected to a common pole and wherein the common pole is arranged either radially inside or radially outside of pole segments, and/or in that the thrust bearing plate is divided into at least two coaxial plate parts which are associated with different bearing branches and which are separated by a non-magnetic material, for example in the form of a spacer ring, wherein the bearing branches associated with the plate parts are arranged coaxially partially in each other or overlapping.

17. The device of claim 16, wherein the common pole comprises one single,
continuous circular or circular ring-shaped pole surface and the coils describe circular arcs substantially concentric with the pole surface.

18. The device of claim 16, wherein the coils follow each other substantially directly in the circumferential direction.

19. The device of claim 16, wherein the pole segments comprise circular arc-shaped pole surfaces which are substantially concentric with the pole surface of the common pole.

20. The device of claim 19, wherein the pole surfaces of the pole segments adjoin each other substantially directly in the circumferential direction.

21. The device of claim 16, wherein the bearing branches are arranged partially in each other and/or overlapping, and an inner diameter of one outer bearing branch is larger than the outer diameter of a plate part of the thrust bearing plate which is associated with an inner bearing branch.

22. The device of claim 16, wherein the distance between an inner pole or pole segment and an outer pole segment or pole respectively of at least one bearing branch becomes larger as distance to the thrust bearing plate increases.

23. The device of claim 16, wherein the distance between the inner and the outer contours of at least one pole or pole segment decreases in the direction of the thrust bearing plate.

24. The device of claim 16, wherein the pole segments comprise, below the coil and between the coil and the pole surface, a projection in a circumferential direction, wherein a length of the projection corresponds approximately to a distance between the end faces of the pole segments.

25. The device of claim 16, wherein an area of the thrust bearing plate in a plane perpendicular to an axis of rotation is smaller than a sum of the areas of the coils and poles and pole segments in a plane perpendicular to the axis of rotation.

26. The device of claim 16, wherein a magnetic thrust bearing comprises an even number of coils arranged symmetrically to the axis of rotation and following each other in the circumferential direction.

27. The device of claim 16, wherein the magnetic thrust bearing comprises at least one permanent magnet.

28. The device of claim 27, wherein the magnetic thrust bearing comprises at least one hybrid magnet with a permanent magnet and an electromagnet.

29. The device of claim 16, wherein at least one of the coils comprises a cross-section converging and/or a radius decreasing towards the thrust bearing plate.

30. The device of claim 16, wherein at least two position sensors are provided which are each associated with different bearing branches.

31. A method for magnetically supporting a rotor with a device of claim 16, wherein the coils are controlled by decoupled regulating systems and on failure of one coil the remaining coils take over the supporting and stabilizing of the rotor.
